(19) United States
(12) Patent Application Publication
(10) Pub. No.: US 2023/0383862 A1
(43) Pub. Date: Nov. 30, 2023

(54) METHOD FOR DISPLAYING AN ACTUATING POSITION OF AN ACTUATING DRIVE, DISPLAY UNIT FOR AN ACTUATING DRIVE, AND ACTUATING DRIVE

(71) Applicant: AUMA RIESTER GMBH & CO. KG, MÜLLHEIM (DE)

(72) Inventors: DENNIS BRUCH, WENDEN (DE); PETER MALUS, MÜLLHEIM (DE); JÜRGEN BECHER, MÜLLHEIM (DE)

(73) Assignee: AUMA RIESTER GMBH & CO. KG, MÜLLHEIM (DE)

(21) Appl. No.: 18/031,738

(22) PCT Filed: Oct. 18, 2021
(86) PCT No.: PCT/EP2021/078810

§ 371 Date: Apr. 13, 2023

(30) Foreign Application Priority Data
Oct. 27, 2020 (DE) 10 2020 128 234.6

(51) Int. Cl. F16K 37/00; G06T 3/60

(52) U.S. Cl. CPC F16K 37/0041; G06T 3/60

(57) ABSTRACT

The invention relates to a display unit which is designed to display a current actuating position of an actuating drive coupled to a valve of a fitting by means of a variable graphical element, wherein the graphical element is shown rotated by a corresponding rotation angle in reaction to a sensor with which the current actuation position is determined.

### CROSS REFERENCE TO RELATED APPLICATIONS

This application is a national stage of International Application No. PCT/EP2021/078810 filed on Oct. 18, 2021, which claims priority to German Patent Application No. 10 2020 128 234.6 filed Oct. 27, 2020, all of which is hereby incorporated by reference in its entirety.

### BACKGROUND

The invention relates to a method for indicating an actuating position of an actuator, in which a graphic element, which corresponds to the actuating position, is displayed on a display unit.

The invention further relates to a display unit for an actuator and a corresponding actuator.

Such methods and display units are known in the case of actuators and serve to indicate the current position of a fitting which is actuated by the actuator. To this end, linear bars have been proposed, the fill level of which indicates a progressive closing or opening of a fitting.

### BRIEF DESCRIPTION

The invention is based on the object of improving the operating properties of an actuator.

To achieve the said object, according to the invention, the features of claim 1 are provided. In particular, to achieve the said object, according to the invention, it is proposed in the case of a method of the type mentioned at the outset that the graphic element is displayed rotated about an axis to indicate the actuating position. A display option is therefore created which requires only a minimal amount of space on a display unit. A current position of a connected valve of a fitting may also be easily ascertained, since a rotational movement seems more obvious than a linear representation. The open position and the closed position may furthermore be easily ascertained and represented by further, fixed markings, which are constant over time.

In an advantageous configuration, it can be provided that the graphic element is loaded in a volatile memory prior to being displayed. The graphic element may therefore be easily processed in order to indicate the current actuating position. Moreover, graphic elements do not have to be stored in the memory for every position in order to depict an actuating position.

It can be provided here that a rotated position of the graphic element, which corresponds to the actuating position, is generated in the volatile memory. A rotation of the graphic element may therefore be achieved via simple routines which require minimal computing capacity.

In an advantageous configuration, it can be provided that the display is realized on a liquid crystal display. Liquid crystal displays have the advantage of a particularly wide temperature range for proper operation.

In an advantageous configuration, it can be provided that an available actuating path is mapped to a rotation angle of 90°. Ambiguities, which can arise when the graphic element assumes the same or an indistinguishable position multiple times during an actuation along the available actuating path, may be avoided.

In an advantageous configuration, it can be provided that the graphic element has a 180° symmetry. A redundancy is therefore created, which can be advantageously used when the direction of rotation of a closing movement of a connected fitting is reversed. It is possible here to selectively assign an end-position or starting-position function to a rotation angle of the graphic element during a closing movement or an opening movement, so that, for the observer, the open position and the closed position can maintain the same rotation angle, even if the direction of rotation for the individual movements is reversed.

In an advantageous configuration, it can be provided that, according to the designation of the end positions of the actuating path as a closed or open valve position, the graphic element is automatically displayed with an offset of 90° or with a reversed direction of rotation. The actuator may therefore be connected to different fittings with contrary closing behaviors without an observer of the display needing to adapt to something different.

This configuration may be advantageously combined with a mapping of the available actuating path to a 90° rotation angle on the graphic element. An advantage here is that the adjacent 90° rotation angles may be used for a contrary closing movement.

Alternatively or additionally, this configuration may be advantageously combined with a 180° symmetry of the graphic element. Therefore, a position of the graphic element at 0° is indistinguishable from that at 180° and can be used to indicate a state of the fitting irrespective of the orientation of the closing direction.

It is particularly favorable if the two previously mentioned configurations are combined with one another. It is therefore possible to define a 0° position and a 180° position as open positions which are selected according to the direction of rotation for the connected fitting, wherein a user is unable to detect a difference regardless of whether the graphic element is in the 0° position or in the 180° position. It is likewise possible to define a 90° position and a 270° position as closed positions, which are selected according to the direction of the connected fitting, wherein a user is unable to detect a difference regardless of whether the graphic element is in the 90° position or in the 270° position.

In an advantageous configuration, it can be provided that a further graphic element is displayed, by means of which a movement beyond an end position of the actuating path may be indicated. Additional information relating to the actual state of the fitting may therefore be displayed.

It can be provided here that the movement may be indicated by a difference in the resolution. The resolution here can be coarser so as to be able to clearly indicate an overshoot (e.g. due to inertia or over-movement).

It can be provided here that the movement may be indicated as a current torque of the actuator. Therefore, an overshoot may be indicated indirectly by indicating an excessive torque application which results in an overshoot of an end position via an elastic deformation.

Alternatively or additionally, to achieve the said object, according to the invention, the features of the alternative independent claim directed to a display unit for an actuator are provided. In particular, to achieve the said object in the case of a display unit of the type described at the outset, it is therefore proposed according to the invention that means are provided for implementing a method according to the invention, in particular as described above or as claimed in one of the claims directed to a method.

In an advantageous configuration, the display unit can further be characterized by a microprocessor and a volatile memory, wherein the microprocessor is designed to calculate a rotated image of a graphic element according to a current actuating position of the actuator and to provide the rotated graphic element in the volatile memory, in particular for display on a display unit.

A preferred application of the invention provides an actuator with a display unit according to the invention for an actuator, in particular as described above or as claimed in one of the claims directed to a display unit for an actuator, and/or with means for implementing a method according to the invention, in particular as described above or as claimed in one of the claims directed to a method.

The invention will now be described in more detail with reference to an exemplary embodiment, but without being restricted to the exemplary embodiment. Further exemplary embodiments may be found by combining the features of individual or multiple claims with one another and/or with individual or multiple features of the exemplary embodiment.

### BRIEF DESCRIPTION OF THE DRAWINGS

FIG. 1 shows a display unit according to the invention in a highly simplified illustration to explain the invention,

FIG. 2 shows four different states of the symbol on the left in FIG. 1,

FIG. 3 shows five different states of the symbol on the right in FIG. 1,

FIG. 4 shows six different states of the symbol in the middle in FIG. 1,

FIG. 5 shows a highly simplified program sequence plan for the method according to the invention and

FIG. 6 shows an actuator with a connected fitting in a highly simplified illustration.

### DETAILED DESCRIPTION

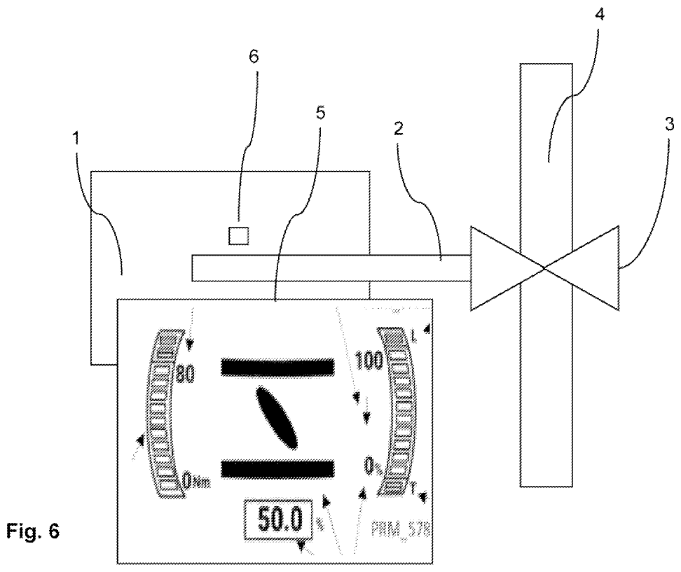

FIG. 6 shows a highly schematic illustration of an actuator 1. The actuator 1 has a motor-driven output shaft 2 to which a valve 3 of a fitting (not illustrated further) is connected in a manner known per se. The valve 3 may be adjusted between an open position, in which a pipe 4 is fluidically conductive, and a closed position, in which the pipe is fluidically blocked, by activating the output shaft 2.

A rotational position of the output shaft 2 may be ascertained, as an absolute value and/or as an incremental value, via a sensor 5, for example a transmitter.

The actuator 1 has a display unit 6, the functionality of which will be described in more detail below.

The display unit 6 here is designed as a liquid crystal display (LCD).

In further exemplary embodiments, the display unit 6 cooperates with the actuator 1, but is formed separately from it.

FIG. 1 shows a possible state of the display unit 6 of FIG. 6.

A graphic element 7 may be rotated about a (virtual) axis 8 in order to indicate a current position of the output shaft 4 or the valve 3. The display here is coupled to the display unit 6 by the sensor 5.

In a numeric window 9, an associated numeric value 10 of the actuating position is displayed—in this case as a percentage of the path already covered up to the closed position.

Fixed markings 11, which extend on both sides of the rotatable graphic element 7, indicate the position of the pipe 4, whilst the graphic element 7 represents the position of the valve 3 in a simple and directly ascertainable manner.

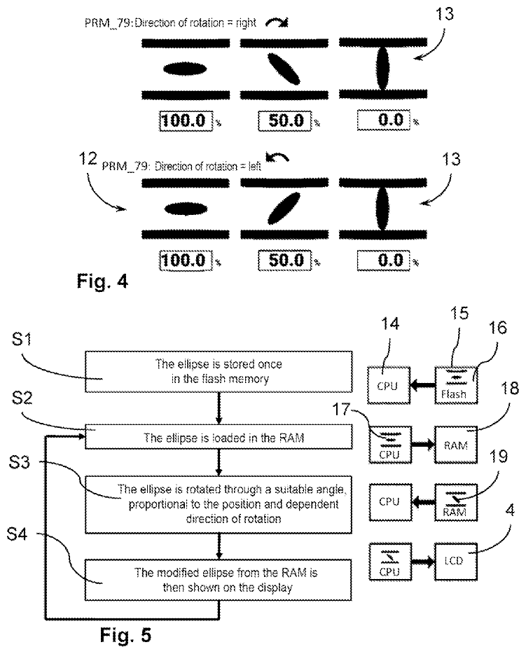

FIG. 4 shows different actuating positions of the graphic element 7 between an open position 12 (top left) and a closed position 13 (top right). The graphic element 7 here is rotated clockwise.

During the initial operation of the actuator 1, it was established, with the aid of the sensor 5, where the open position 12 and the closed position 13 lie. This reveals the direction in which the graphic element 7 must rotate to move from the open position 12 to the closed position 13.

The bottom row in FIG. 4 represents the reverse movement from the closed position 13 to the open position 12. The direction of rotation for the movement of the graphic element 7 is reversed.

On the other hand, however, if the valve 3 has a mirror-inverted design, the open position 12 and the closed position 13 must swap over at the output shaft 4.

So that the open position 12 and the closed position 13 can remain unchanged, in particular relative to the markings 11, the display unit 6 switches so that the graphic element 7 rotates anti-clockwise in order to move from the open position 12 to the closed position 13.

The open position 12 and closed position 13 here are shown rotated through 90° with respect to one another by mapping the available actuating path between the end positions to an angular range of 90°.

A rotation between the open position 12 and the closed position 13 through 90° here and the 180° rotational symmetry (in relation to the axis 8) of the graphic element enables the end positions of the actuating movement to remain the same and the coupling of the position of the graphic element 7 to the movement of the output shaft 4 to remain unchanged.

In FIG. 4, top right, the graphic element 7 in this case rotates further clockwise from the starting position—now the closed position 13—until the position (rotated through 180°) at the top left—the open position—is assumed.

In other words, an offset of 90° is added (or removed) to (from) the coupling between the output shaft 4 and the graphic element 7.

This offset can be determined automatically based on the position for the open position 12 and closed position 13 and/or a direction of travel between the two during the initial operation.

FIG. 5 shows, in a highly simplified form, how the rotation of the graphic element 7 is realized.

A microprocessor 14, in an initialization step S1, loads a representation 15 of the graphic element 7 from a non-volatile memory 16, for example a flash memory.

In an initial step S2, the current representation 17 of the graphic element 7 is loaded in a volatile memory 17, in this case a RAM.

In a calculating step S3, the graphic element 7 is processed with the aid of standard commands in the volatile memory 18 until a rotated position 19 is calculated. The rotation angle here is derived from measurement data which the microprocessor 14 receives from the sensor 5.

In a representation step S4, the microprocessor 14 (or a further graphic processor) activates the display unit so that—preferably in a defined region—the graphic element 7 is displayed in the position in which it is stored in the volatile memory 18.

The sequence is then continued in step S1.

FIG. 1 shows a further graphic element 20, with which a movement beyond an end position of the actuating path may be displayed (T=closed position 13 with (by way of example) cut-off type TORQUE, L=open position 12 with (by way of example) cut-off type ACTUATING POSITION). A number of part markings 21 are shaded here to correspond to the actuating path.

This is realized in that part markings 22 with a coarser resolution are provided outside the actuating path (specified during the initial operation). Even with only a minimal overshoot of the end positions (during which the output shaft 4 can be slightly elastically deformed and clearances in the fitting, couplings and gears can be exploited), the adjacent display field is activated, regardless of the amount of overshoot of the end position.

FIG. 3 shows a full movement from an under-movement (left), i.e. an undershoot of the lowest actuating position, via the closed position 13 (2nd image from the left) and the open position 12 (2nd image from the right) to an over-movement (right).

A further graphic element 23 can alternatively indicate that the maximum cut-off torque has been exceeded. The torque on the output shaft 4 is indicated—according to a corresponding sensor here—by shading a corresponding number of part markings.

If a threshold value (for example 80 Nm here) is exceeded, special part markings 22 are shaded so that the user ascertains that the movement towards the end position involves a torque.

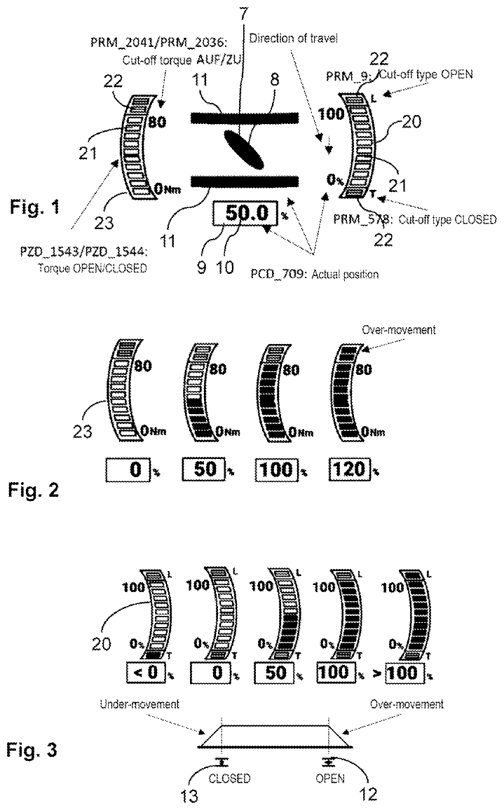

FIG. 2 shows a (torque-free) idle position (left), the movement along the actuating path with a low torque (2nd image from the left), the maximum cut-off torque being reached (2nd image from the right) and the cut-off torque being exceeded (right).

The invention therefore relates to a display unit 6, which is designed to indicate a current actuating position of an actuator 1, which is coupled to a valve 3 of a fitting, by means of a variable graphic element 7, wherein, in response to a sensor with which the current actuating position is determined, the graphic element 7 is shown rotated through a corresponding rotation angle.

1.-10. (canceled)

11. A method for indicating an actuating position of an actuator (1), in which a graphic element (7), which corresponds to the actuating position, is displayed on a display unit (6), wherein the graphic element (7) is displayed rotated about an axis (8) to indicate the actuating position and in that the graphic element (7) is loaded in a volatile memory (18) prior to being displayed, wherein a rotated position of the graphic element (7), which corresponds to the actuating position, is generated in the volatile memory (18).

12. The method of claim 11 wherein the display is realized on a liquid crystal display.

13. The method of claim 11 wherein an available actuating path is mapped to a rotation angle of 90°.

14. The method of claim 11 wherein the graphic element (7) has a 180° symmetry.

15. The method of claim 11 wherein, according to the designation of the end positions of the actuating path as a closed or open valve position, the graphic element (7) is automatically displayed with an offset of 90° or with a reversed direction of rotation.

16. The method of claim 11 wherein a further graphic element (20, 23) is displayed, by means of which a movement beyond an end position of the actuating path may be indicated (22), in particular by a difference in the resolution and/or as a current torque of the actuator (1).

17. A display unit for an actuator (1) having means for implementing a method as claimed in claim 11.

18. A display unit (6) as claimed in claim 17, characterized by a microprocessor (14) and a volatile memory (18), wherein the microprocessor (14) is designed to calculate a rotated representation (19) of a graphic element (7) according to a current actuating position of the actuator (1) and to provide the rotated graphic element (7), preferably in the volatile memory (18), in particular for display on the display unit (6).

19. An actuator (1) having a display unit (6) as claimed in claim 17.

20. An actuator (1) having a means for implementing a method as claimed in claim 11.
